(19) United States
(12) Patent Application Publication
(10) Pub. No.: US 2023/0049656 A1
(43) Pub. Date: Feb. 16, 2023

(54) METHOD OF PROCESSING IMAGE, ELECTRONIC DEVICE, AND MEDIUM

(71) Applicant: Apollo Intelligent Connectivity (Beijing) Technology Co., Ltd., Beijing (CN)

(72) Inventors: Xiaoyun WANG, Beijing (CN); Mingzhi CHEN, Beijing (CN); Zhao WANG, Beijing (CN)

(21) Appl. No.: 17/973,719

(22) Filed: Oct. 26, 2022

(30) Foreign Application Priority Data
Oct. 27, 2021 (CN) 202111259248.6

(51) Int. Cl. G06T 7/00; G06V 10/764; H04N 1/60

(52) U.S. Cl. CPC G06T 7/0002; G06V 10/764; H04N 1/6005; G06T 2207/10024; G06T 2207/30168

(57) ABSTRACT

The present disclosure provides a method of processing an image, a device, and a medium. The method of processing the image includes: performing an image processing on an original image to obtain a component image for brightness of the original image; determining at least one of the original image and the component image as an image to be processed; classifying a pixel in the image to be processed, so as to obtain a classification result; processing the image to be processed according to the classification result, so as to obtain a target image; and determining an image quality of the original image according to the target image.

### CROSS-REFERENCE TO RELATED APPLICATION(S)

This application claims the priority of Chinese Patent Application No. 202111259248.6, filed on Oct. 27, 2021, the entire contents of which are hereby incorporated by reference.

### TECHNICAL FIELD

The present disclosure relates to a field of an artificial intelligence technology, in particular to fields of autonomous driving, intelligent transportation, computer vision and deep learning technologies. More specifically, the present disclosure relates to a method of processing an image, an electronic device, and a medium.

### BACKGROUND

In some scenarios, an image recognition needs to be performed on an acquired image to determine an image quality of the acquired image. For example, in a field of traffic, an image of traffic may be captured by a camera, so that a traffic condition may be determined according to the image. However, in a related art, when recognizing an image quality of an image, an effect of recognition is not good, and the recognition is costly.

### SUMMARY

The present disclosure provides a method of processing an image, an electronic device, and a storage medium.

According to an aspect of the present disclosure, a method of processing an image is provided, including: performing an image processing on an original image to obtain a component image for brightness of the original image; determining at least one of the original image and the component image as an image to be processed; classifying a pixel in the image to be processed, so as to obtain a classification result; processing the image to be processed according to the classification result, so as to obtain a target image; and determining an image quality of the original image according to the target image.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of processing the image as described above.

According to another aspect of the present disclosure, a non-transitory computer-readable storage medium having computer instructions therein is provided, and the computer instructions are configured to cause a computer to implement the method of processing the image as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure.

FIG. 1 schematically shows an application scenario of a method and an apparatus of processing an image according to embodiments of the present disclosure.

FIG. 2 schematically shows a flowchart of a method of processing an image according to embodiments of the present disclosure.

FIG. 3 schematically shows a method of processing an image according to embodiments of the present disclosure.

FIG. 4 schematically shows a method of processing an image according to other embodiments of the present disclosure.

FIG. 5 schematically shows a schematic diagram of a method of processing an image according to other embodiments of the present disclosure.

FIG. 6 schematically shows a system architecture of a method of processing an image according to embodiments of the present disclosure.

FIG. 7 schematically shows a schematic diagram of a method of processing an image according to embodiments of the present disclosure.

FIG. 8 schematically shows a sequence diagram of a method of processing an image according to embodiments of the present disclosure.

FIG. 9 schematically shows a block diagram of an apparatus of processing an image according to embodiments of the present disclosure.

FIG. 10 shows a block diagram of an electronic device for performing an image processing for implementing embodiments of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

The terms used herein are for the purpose of describing specific embodiments only and are not intended to limit the present disclosure. The terms “comprising”, “including”, “containing”, etc. used herein indicate the presence of the feature, step, operation and/or part, but do not exclude the presence or addition of one or more other features, steps, operations or parts.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or too rigid way.

In a case of using the expression similar to “at least one of A, B and C”, it should be explained according to the meaning of the expression generally understood by those skilled in the art (for example, “a system including at least one of A, B and C” should include but not be limited to a system including only A, a system including only B, a system including only C, a system including A and B, a system including A and C, a system including B and C, and/or a system including A, B and C).

Embodiments of the present disclosure provide a method of processing an image, including: performing an image processing on an original image to obtain a component image for brightness of the original image; determining at least one of the original image and the component image as an image to be processed; classifying a pixel in the image to be processed, so as to obtain a classification result; processing the image to be processed according to the classification result, so as to obtain a target image; and determining an image quality of the original image according to the target image.

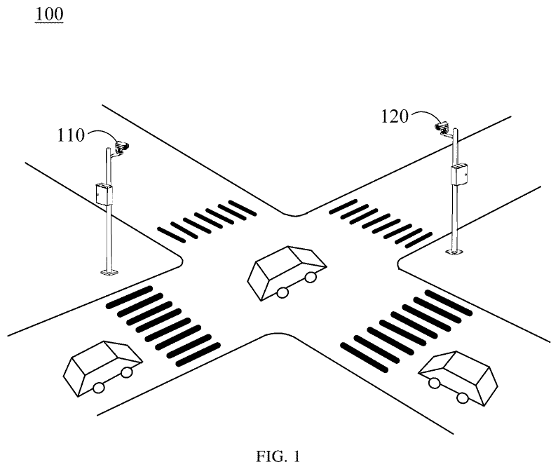

FIG. 1 schematically shows an application scenario of a method and an apparatus of processing an image according to embodiments of the present disclosure. It should be noted that FIG. 1 is only an example of the application scenario to which embodiments of the present disclosure may be applied to help those skilled in the art understand the technical content of the present disclosure, but it does not mean that embodiments of the present disclosure may not be applied to other devices, systems, environments or scenarios.

As shown in FIG. 1, an application scenario 100 of the present disclosure includes, for example, a plurality of cameras 110 and 120.

The plurality of cameras 110 and 120 may be used to, for example, capture video streams. A traffic condition may be obtained by identifying image frames in the video streams. The plurality of cameras 110 and 120 may be installed on a road device, or may be installed on an autonomous driving vehicle to capture video streams in real time during a driving process of the autonomous driving vehicle.

In some scenarios, due to various external environmental reasons, such as wind, rain, freezing, etc., the video stream captured by the camera may be abnormal. For example, an image frame in the video stream may have noise points, blurring, occlusion, color deviation or brightness abnormality, etc., which may result in a poor image quality. When the recognition is performed based on a video stream with a poor image quality, it is difficult to accurately identify vehicles, license plates, pedestrians, and other traffic conditions at intersections.

Embodiments of the present disclosure may be implemented to determine the image quality by means of image recognition, so as to timely detect whether the camera is abnormal according to the image quality. Different from detecting an abnormal shooting of the camera by means of manual inspection, embodiments of the present disclosure may reduce a maintenance cost of the camera.

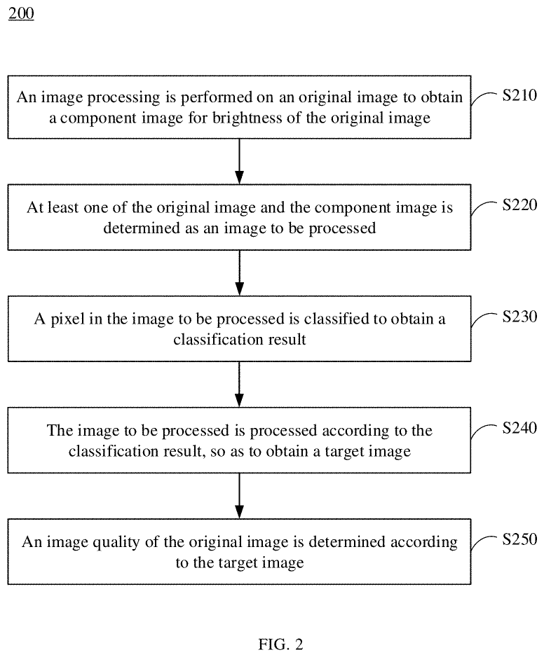

Embodiments of the present disclosure provide a method of processing an image. The method of processing the image according to exemplary embodiments of the present disclosure will be described below with reference to FIG. 2 to FIG. 8 in combination with the application scenario of FIG. 1.

FIG. 2 schematically shows a flowchart of a method of processing an image according to embodiments of the present disclosure.

As shown in FIG. 2, a method 200 of processing an image of embodiments of the present disclosure may include, for example, operation S210 to operation S250.

In operation S210, an image processing is performed on an original image to obtain a component image for brightness of the original image.

In operation S220, at least one of the original image and the component image is determined as an image to be processed.

In operation S230, a pixel in the image to be processed is classified to obtain a classification result.

In operation S240, the image to be processed is processed according to the classification result, so as to obtain a target image.

In operation S250, an image quality of the original image is determined according to the target image.

Exemplarily, the original image may be, for example, an image captured by a camera. The original image may contain, for example, hue, saturation, brightness and other information. A brightness component image for the original image may be obtained by processing the original image. Then, the original image and the component image may be compared to obtain a comparison result, which may include, for example, a foreground information and a background information of the image. The image to be processed may be determined from the original image and the component image according to the comparison result.

Next, each pixel in the image to be processed may be classified to obtain a classification result containing a plurality of categories, and then the image to be processed may be processed based on the classification result to obtain the target image. When the target image is obtained, the image quality of the original image may be determined according to the target image. The image quality may indicate, for example, whether a picture of the original image is occluded.

According to embodiments of the present disclosure, by acquiring a component image for brightness of the original image, then classifying the pixel in the original image or the component image to obtain a target image, and finally determining the image quality of the original image according to the target image, an effect and an accuracy of a detection of the image quality may be improved, and a detection cost may be reduced.

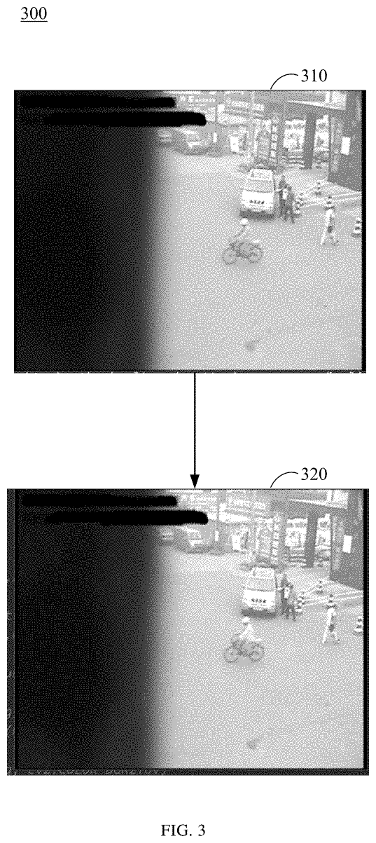

FIG. 3 schematically shows a method of processing an image according to embodiments of the present disclosure.

As shown in FIG. 3, according to an embodiment 300 of the present disclosure, for example, an original image 310 may be converted to an HSV (Hue Saturation Value) color space to obtain a plurality of component images, and then a component image 320 for brightness may be determined from the plurality of component images.

Exemplarily, in the HSV color space, a point in RGB color space may be represented, for example, in a cylindrical coordinate system. The original image 310 includes a component image for hue, a component image for saturation, and a component image for brightness (value) in the HSV color space. The component image 320 for brightness (value) may be determined from the plurality of component images. The component image 320 is more sensitive to a brightness information, so that the foreground information and the background information may be better distinguished according to the component image 320 in some cases.

When the component image 320 for brightness is obtained, one of the original image 310 and the component image 320 may be selected as the image to be processed.

For example, a first level of difference between the foreground information and the background information of the original image 310 may be determined. The greater the first level of difference, the more obvious the distinction between the foreground information and the background information. In the original image 310, the foreground information may include, for example, an image information of an occluded portion (black portion), and the background information may include, for example, an image information of an un-occluded portion.

For example, a second level of difference between the foreground information and the background information of the component image 320 may be determined. The greater the second level of difference, the more obvious the distinction between the foreground information and the background information. In the component image 320, the foreground information may include, for example, an image information of an occluded portion (black portion), and the background information may include, for example, an image information of an un-occluded portion

Then, according to the first level of difference and the second level of difference, the original image 310 or the component image 320 may be determined as the image to be processed. For example, when the first level of difference is greater than the second level of difference, the original image 310 may be determined as the image to be processed. When the second level of difference is greater than the first level of difference, the component image 320 may be determined as the image to be processed.

According to embodiments of the present disclosure, according to the difference between the foreground information and the background information, an image with a greater level of difference between the foreground information and the background information is selected from the original image and the component image as the image to be processed. The greater the level of difference, the more obvious the distinction between the foreground information and the background information, so that an accuracy of subsequent processing of the image to be processed may be improved.

FIG. 4 schematically shows a method of processing an image according to other embodiments of the present disclosure.

As shown in FIG. 4, according to an embodiment 400 of the present disclosure, when the image to be processed is obtained, a pixel in the image to be processed may be classified to obtain a classification result.

For example, for each pixel in the image to be processed, if a pixel value of the pixel is greater than a threshold value, the pixel may be divided into a first group. If the pixel value of the pixel is less than or equal to the threshold value, the pixel may be divided into a second group. Then, the first group and the second group may be determined as the classification result. The threshold value may include, for example, 10, 20, and the like.

When the first group and the second group are obtained, the pixel value of the pixel belonging to the first group in the image to be processed may be configured as a first score, and the pixel value of the pixel belonging to the second group in the image to be processed may be configured as a second score. For example, the first score may be 0, and the second score may be 255

Then, a target image 410 may be obtained from the image to be processed according to the first score and the second score. The target image 410 may be, for example, a binary image. A portion with a pixel value of 0 in the binary image may be, for example, a foreground portion, and a portion with a pixel value of 255 in the binary image may be, for example, a background portion.

According to embodiments of the present disclosure, the target image is obtained by performing a binarization on the image to be processed, so that the distinction between the foreground portion and the background portion in the target image is more obvious, and the subsequent processing accuracy for the target image may be improved.

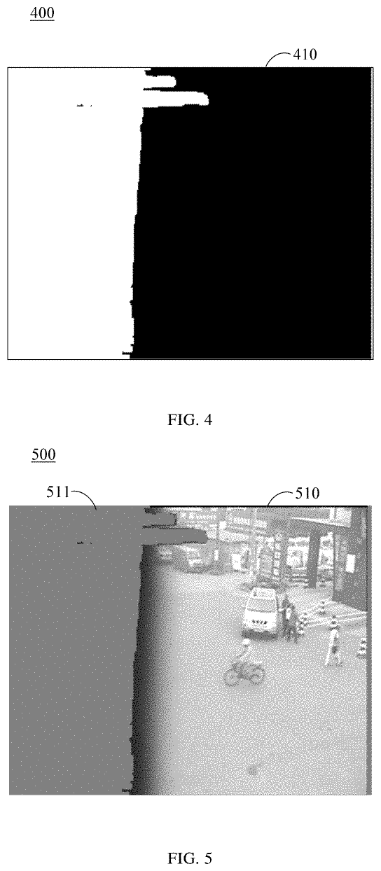

FIG. 5 schematically shows a method of processing an image according to other embodiments of the present disclosure.

As shown in FIG. 5, according to an embodiment 500 of the present disclosure, when the target image is obtained, a connected component 511 of an original image 510 may be determined according to the first score or the second score of each pixel in the target image. For example, for each pixel in the original image 510, the connected component 511 may be determined according to the first score or the second score of the pixel corresponding to the target image. Each pixel in the connected component 511 of the original image 510 may correspond to, for example, the second score (255) of the target image. In FIG. 5, the connected component 511 is represented by a gray region.

When the connected component 511 in the original image 510 is determined, an image quality of the original image 510 may be determined according to the connected component 511. The connected component 511 may be, for example, an occluded portion in the original image 510.

For example, an occlusion rate of the original image may be determined according to a ratio of a component area of the connected component to an image area of the original image. Then, the image quality of the original image may be determined according to the occlusion rate. The greater the occlusion rate, the worse the image quality.

According to embodiments of the present disclosure, when the target image is obtained by performing a binarization on the image to be processed, the connected component in the original image is determined according to the target image, and then the occlusion rate is determined according to the ratio of the component area of the connected component to the image area of the original image, so as to determine the image quality according to the occlusion rate. Through embodiments of the present disclosure, an effect and an accuracy of a detection of the image quality may be improved, and a detection cost may be reduced.

In another example of the present disclosure, it is also possible to determine a level of blur, a level of color deviation, a level of brightness abnormality and other information of the original image, so as to determine the image quality of the original image. Exemplarily, embodiments of the present disclosure may be implemented to comprehensively determine the image quality of the original image according to the level of occlusion, the level of blur, the level of color deviation, and the level of brightness abnormality of the original image.

In an example, for the level of blur of the original image, a sharpness evaluation method without reference image may be used, and a square of a gray scale difference between two adjacent pixels may be calculate using a Brenner gradient function. For example, the Brenner gradient function may be defined as Equation (1).

D(f)=Σ_{y}Σₓ|f(x+2, y)−f(x, y)|² (1)

where f (x, y) represents a gray value of a pixel point (x, y) in an original image f, and D (f) represents a calculation result of a definition (variance) of the original image.

The variance D(f) is calculated for each pixel of the original image, so as to obtain a cumulative variance over all pixels. When the cumulative variance is less than a predetermined threshold, it is determined that the original image has a poor image quality, that is, the original image is blurry.

In another example, for the level of color deviation of the original image, when the original image is an RGB color image, the RGB color image may be converted to a CIE L*a*b* space, where L* represents a lightness of image, a* represents a red/green component of image, and b* represents a yellow/blue component of image. Generally, for an image with a color deviation, a mean value of a* component and a mean value of b* component may deviate far from an origin, and the variances thereof may also be small. Therefore, by calculating the mean values and variances for a* and b* components of the image, it is possible to evaluate whether the image has a color deviation according to the mean values and the variances.

$${d}_{a} = \frac{{\sum }_{i = 1}^{m} {\sum }_{j = 1}^{n} a}{mn} {d}_{b} = \frac{{\sum }_{i = 1}^{m} {\sum }_{j = 1}^{n} b}{mn} \qquad ( 2 )$$

$$D = \sqrt{{d}_{a}^{2} + {d}_{b}^{2}} \qquad ( 3 )$$

$${M}_{a} = \frac{{\sum }_{i = 1}^{m} {\sum }_{j = 1}^{n} ( a - {d}_{a} )}{mn} {M}_{b} = \frac{{\sum }_{i = 1}^{m} {\sum }_{j = 1}^{n} ( b - {d}_{b} )}{mn} \qquad ( 4 )$$

$$M = \sqrt{{M}_{a}^{2} + {M}_{b}^{2}} \qquad ( 5 )$$

$$K = D / M \qquad ( 6 )$$

where dₐ and d_{b} respectively represent the mean value of the a* component and the mean value of the b* component of the image, and Mₐ and M_{b} respectively represent the variance of the a* component and the variance of the b* component of the image.

In Equation (2) to Equation (6), m and n respectively represent a width and a height of the image, in pixels. On an a-b chromaticity plane, an equivalent circle has a center with coordinates (dₐ, d_{b}) and a radius M. A distance from the center of the equivalent circle to an origin of a neutral axis of the a-b chromaticity plane (a=0, b=0) is D. An overall color deviation of the image may be determined by a specific position of the equivalent circle on the a-b chromaticity plane. When d_{a>}0, the image tends to be red, otherwise the image tends to be green. When d_{b>}0, the image tends to be yellow, otherwise the image tends to be blue. The greater the value of the color deviation factor K, the greater the level of color deviation of the image.

In another example, for the level of brightness abnormality of the original image, when the original image is a gray scale image, a mean value dₐ and a mean deviation Mₐ of the gray scale image may be calculated by Equation (7) to Equation (11). When the image has a brightness abnormality, the mean value may deviate from a mean point (the mean point may be, for example, 128), and the mean deviation may be small. By calculating the mean value and the mean deviation of the image, it is possible to evaluate whether the image is overexposed or underexposed according to the mean value and the mean deviation.

$${d}_{a} = \frac{{\sum }_{i = 0}^{N - 1} ( {x}_{i} - 128 )}{N} \qquad ( 7 )$$

$$D = \vert {d}_{a} \vert \qquad ( 8 )$$

$${M}_{a} = \frac{{\sum }_{i = 0}^{255} \vert ( i - 128 ) - {d}_{a} \vert \times Hist [ i ]}{N} \qquad ( 9 )$$

$$M = \vert {M}_{a} \vert \qquad ( 10 )$$

$$K = D / M \qquad ( 11 )$$

In Equation (7), xᵢ represents a pixel value of an i^{th} pixel in the original image, and N is the total number of pixels in the original image; Hist[i] in Equation (9) is a number of pixels having a pixel value i in the original image.

When a brightness factor K is less than a predetermined threshold, the image has a normal brightness. When the brightness factor is greater than or equal to the predetermined threshold, the image has an abnormal brightness. Specifically, the mean value dₐ may be further determined when the brightness factor is greater than or equal to the predetermined threshold. If the mean value dₐ is greater than 0, it indicates that the image brightness tends to be large, and if the mean value dₐ is less than or equal to 0, it indicates that the image brightness tends to be small.

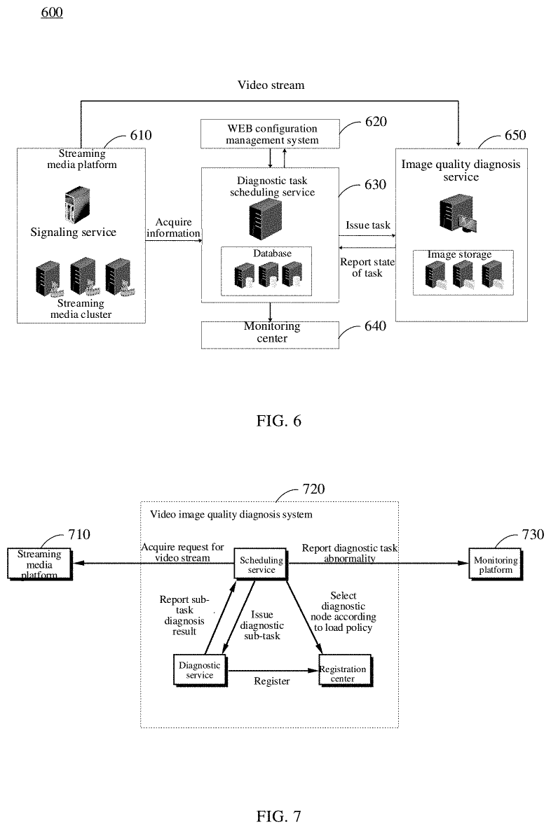

FIG. 6 schematically shows a system architecture of a method of processing an image according to embodiments of the present disclosure.

As shown in FIG. 6, a system architecture 600 of video image quality diagnosis includes, for example, a streaming media platform 610, a WEB configuration management system 620, a diagnostic task scheduling service 630, a monitoring center 640, and an image quality diagnosis service 650.

The streaming media platform 610 may include, for example, a signaling service and a streaming media cluster. The streaming media platform 610 is used to acquire a video stream that includes an image for diagnosis.

The WEB configuration management system 620 is used to manage a diagnostic task, which may include, for example, an image quality diagnosis of the image in the video stream.

The diagnostic task scheduling service 630 is used to schedule the diagnostic task. The diagnostic task scheduling service 630 may include a database for storing a task information.

The monitoring center 640 is used to monitor an execution of task in the diagnostic task scheduling service 630.

The image quality diagnosis service 650 is used to acquire a video stream from the streaming media platform 610 according to a task issued by the diagnostic task scheduling service 630, perform an image quality diagnosis on an image in the video stream, and report a state of a task execution to the diagnostic task scheduling service 630.

FIG. 7 schematically shows a method of processing an image according to embodiments of the present disclosure.

As shown in FIG. 7, embodiments according to the present disclosure may include, for example, a streaming media platform 710, a video image quality diagnosis system 720, and a monitoring platform 730.

The streaming media platform 710 is used to generate a video stream.

The video image quality diagnosis system 720 may include, for example, a scheduling service, a diagnostic service, and a registration center. The scheduling service may send a request to the streaming media platform 710 to acquire a video stream. The scheduling service may further issue a diagnostic sub-task to the diagnostic service. When the diagnostic sub-task is executed completely, the diagnostic service may report a sub-task diagnosis result to the scheduling service. The diagnostic service may be registered with the registration center. The scheduling service may further select a diagnosis node according to a load policy, so that the diagnostic sub-task may be issued according to the diagnosis node. The scheduling service may further report an abnormal diagnostic task to the monitoring platform 730.

The monitoring platform 730 is used to monitor a state of the diagnostic task.

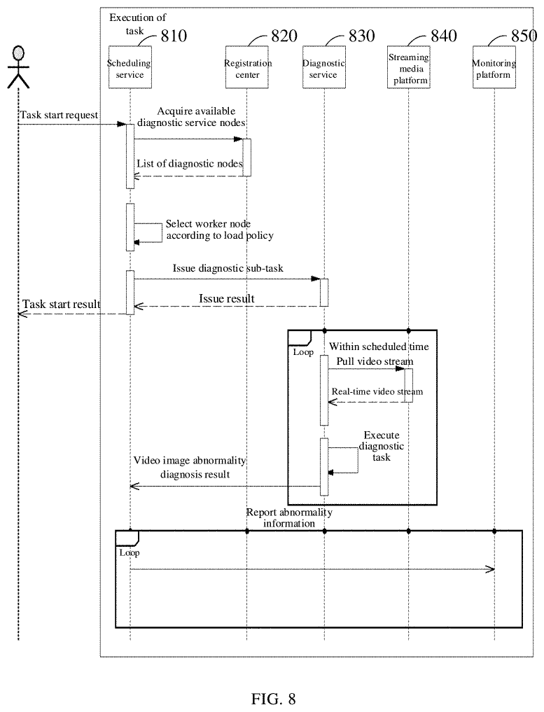

FIG. 8 schematically shows a sequence diagram of a method of processing an image according to embodiments of the present disclosure.

As shown in FIG. 8, embodiments according to the present disclosure may include, for example, a scheduling service 810, a registration center 820, a diagnostic service 830, a streaming media platform 840, and a monitoring platform 850.

When receiving a task start request from a user, the scheduling service 810 acquires available diagnostic service nodes from the registration center 820. The registration center 820 returns a list of diagnostic nodes to the scheduling service 810. The scheduling service 810 selects a worker node according to a load policy base on the list of nodes.

When the worker node is selected, the scheduling service 810 issues a diagnostic sub-task to the diagnostic service 830, and the diagnostic service 830 feeds back a result of issuing. When receiving the result of issuing, the scheduling service 810 feeds back a task start result to the user.

The diagnostic service 830 executes the diagnostic task in a loop within a scheduled time. For example, the diagnostic service 830 sends a request to the streaming media platform 840 to pull a video stream, the streaming media platform 840 returns a real-time video stream to the diagnostic service 830, and then the diagnostic service 830 executes an image quality diagnosis task according to the video stream, and returns a video image abnormality diagnosis result to the scheduling service 810.

When receiving the video image abnormality diagnosis result, the scheduling service 810 may report an abnormality information to the monitoring platform 850.

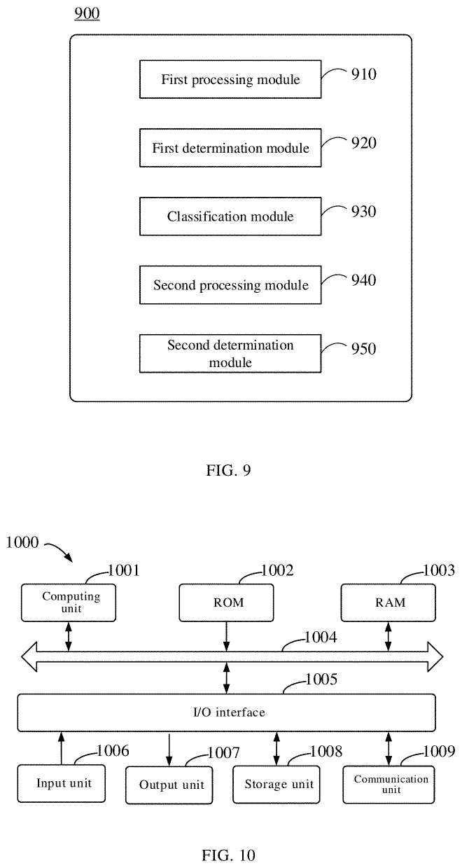

FIG. 9 schematically shows a block diagram of an apparatus of processing an image according to embodiments of the present disclosure.

As shown in FIG. 9, an apparatus 900 of processing an image of embodiments of the present disclosure includes, for example, a first processing module 910, a first determination module 920, a classification module 930, a second processing module 940, and a second determination module 950.

The first processing module 910 may be used to perform an image processing on an original image to obtain a component image for brightness of the original image. According to embodiments of the present disclosure, the first processing module 910 may perform, for example, the operation S210 described above with reference to FIG. 2, which will not be repeated here.

The first determination module 920 may be used to determine at least one of the original image and the component image as an image to be processed. According to embodiments of the present disclosure, the first determination module 920 may perform, for example, the operation S220 described above with reference to FIG. 2, which will not be repeated here.

The classification module 930 may be used to classify a pixel in the image to be processed, so as to obtain a classification result. According to embodiments of the present disclosure, the classification module 930 may perform, for example, the operation S230 described above with reference to FIG. 2, which will not be repeated here.

The second processing module 940 may be used to process the image to be processed according to the classification result, so as to obtain a target image. According to embodiments of the present disclosure, the second processing module 940 may perform, for example, the operation S240 described above with reference to FIG. 2, which will not be repeated here.

The second determination module 950 may be used to determine an image quality of the original image according to the target image. According to embodiments of the present disclosure, the second determination module 950 may perform, for example, the operation S250 described above with reference to FIG. 2, which will not be repeated here.

According to embodiments of the present disclosure, for each pixel in the image to be processed, the classification module 930 includes a first dividing sub-module, a second dividing sub-module, and a first determination sub-module. The first dividing sub-module is used to divide the pixel into a first group in response to determining that a pixel value of the pixel is greater than a threshold value. The second dividing sub-module is used to divide the pixel into a second group in response to determining that the pixel value of the pixel is less than or equal to the threshold value. The first determination sub-module is used to determine the first group and the second group as the classification result.

According to embodiments of the present disclosure, the second processing module 940 includes a first configuring sub-module, a second configuring sub-module, and an obtaining sub-module. The first configuring sub-module is used to configure a pixel value of a pixel in the first group as a first score. The second configuring sub-module is used to configure a pixel value of a pixel in the second group as a second score. The obtaining sub-module is used to obtain the target image according to the first score and the second score.

According to embodiments of the present disclosure, the second determination module 950 includes a second determination sub-module and a third determination sub-module. The second determination sub-module is used to determine a connected component of the original image according to the target image. The third determination sub-module is used to determine the image quality of the original image according to the connected component.

According to embodiments of the present disclosure, the third determination sub-module includes a first determination unit and a second determination unit. The first determination unit is used to determine an occlusion rate of the original image according to a ratio of a component area of the connected component to an image area of the original image. The second determination unit is used to determine the image quality of the original image according to the occlusion rate.

According to embodiments of the present disclosure, the first determination module 920 includes a fourth determination sub-module, a fifth determination sub-module, and a sixth determination sub-module. The fourth determination sub-module is used to determine a first level of difference between a foreground information of the original image and a background information of the original image. The fifth determination sub-module is used to determine a second level of difference between a foreground information of the component image and a background information of the component image. The sixth determination sub-module is used to determine the original image or the component image as the image to be processed, according to the first level of difference and the second level of difference.

According to embodiments of the present disclosure, the first processing module 910 includes a conversion sub-module and a seventh determination sub-module. The conversion sub-module is used to convert the original image into an HSV color space to obtain a plurality of component images. The seventh determination sub-module is used to determine the component image for brightness from the plurality of component images.

In the technical solution of the present disclosure, an acquisition, a storage, a use, a processing, a transmission, a provision and a disclosure of user personal information involved comply with provisions of relevant laws and regulations, and do not violate public order and good custom.

According to embodiments of the present disclosure, the present disclosure further provides an electronic device, a readable storage medium, and a computer program product.

FIG. 10 shows a block diagram of an electronic device for performing an image processing for implementing embodiments of the present disclosure.

FIG. 10 shows a schematic block diagram of an exemplary electronic device 1000 for implementing embodiments of the present disclosure. The electronic device 1000 is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and steps described above, such as the method of processing the image. For example, in some embodiments, the method of processing the image may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of processing the image described above. Alternatively, in other embodiments, the computing unit 1001 may be configured to perform the method of processing the image by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing an image, comprising:
performing an image processing on an original image to obtain a component image for brightness of the original image;
determining at least one of the original image and the component image as an image to be processed;
classifying a pixel in the image to be processed, so as to obtain a classification result;
processing the image to be processed according to the classification result, so as to obtain a target image; and
determining an image quality of the original image according to the target image.

2. The method of claim 1, wherein the classifying a pixel in the image to be processed, so as to obtain a classification result comprises: for each pixel in the image to be processed,
dividing the pixel into a first group in response to determining that a pixel value of the pixel is greater than a threshold value;
dividing the pixel into a second group in response to determining that the pixel value of the pixel is less than or equal to the threshold value; and
determining the first group and the second group as the classification result.

3. The method of claim 2, wherein the processing the image to be processed according to the classification result, so as to obtain a target image comprises:
configuring a pixel value of a pixel in the first group as a first score;
configuring a pixel value of a pixel in the second group as a second score; and
obtaining the target image according to the first score and the second score.

4. The method of claim 3, wherein the determining an image quality of the original image according to the target image comprises:
determining a connected component of the original image according to the target image; and
determining the image quality of the original image according to the connected component.

5. The method of claim 4, wherein the determining the image quality of the original image according to the connected component comprises:
determining an occlusion rate of the original image according to a ratio of a component area of the connected component to an image area of the original image; and
determining the image quality of the original image according to the occlusion rate.

6. The method of claim 1, wherein the determining at least one of the original image and the component image as an image to be processed comprises:
determining a first level of difference between a foreground information of the original image and a background information of the original image;
determining a second level of difference between a foreground information of the component image and a background information of the component image; and
determining the original image or the component image as the image to be processed, according to the first level of difference and the second level of difference.

7. The method of claim 1, wherein the performing an image processing on an original image to obtain a component image for brightness of the original image comprises:
converting the original image into an HSV color space to obtain a plurality of component images; and
determining the component image for brightness from the plurality of component images.

8. An electronic device, comprising:
at least one processor; and
a memory communicatively connected to the at least one processor, wherein the memory stores instructions executable by the at least one processor, and the instructions, when executed by the at least one processor, cause the at least one processor to implement method of processing an image, comprising operations of:
performing an image processing on an original image to obtain a component image for brightness of the original image;
determining at least one of the original image and the component image as an image to be processed;
classifying a pixel in the image to be processed, so as to obtain a classification result;
processing the image to be processed according to the classification result, so as to obtain a target image; and
determining an image quality of the original image according to the target image.

9. The electronic device of claim 8, wherein the instructions, when executed by the processor, cause the processor further to implement operations of: for each pixel in the image to be processed,
dividing the pixel into a first group in response to determining that a pixel value of the pixel is greater than a threshold value;
dividing the pixel into a second group in response to determining that the pixel value of the pixel is less than or equal to the threshold value; and
determining the first group and the second group as the classification result.

10. The electronic device of claim 9, wherein the instructions, when executed by the processor, cause the processor further to implement operations of:
configuring a pixel value of a pixel in the first group as a first score;
configuring a pixel value of a pixel in the second group as a second score; and
obtaining the target image according to the first score and the second

11. The electronic device of claim 10, wherein the instructions, when executed by the processor, cause the processor further to implement operations of:
determining a connected component of the original image according to the target image; and
determining the image quality of the original image according to the connected component.

12. The electronic device of claim 11, wherein the instructions, when executed by the processor, cause the processor further to implement operations of:
determining an occlusion rate of the original image according to a ratio of a component area of the connected component to an image area of the original image; and
determining the image quality of the original image according to the occlusion rate.

13. The electronic device of claim 8, wherein the instructions, when executed by the processor, cause the processor further to implement operations of:
determining a first level of difference between a foreground information of the original image and a background information of the original image;
determining a second level of difference between a foreground information of the component image and a background information of the component image; and
determining the original image or the component image as the image to be processed, according to the first level of difference and the second level of difference.

14. The electronic device of claim 8, wherein the instructions, when executed by the processor, cause the processor further to implement operations of:
converting the original image into an HSV color space to obtain a plurality of component images; and
determining the component image for brightness from the plurality of component images.

15. A non-transitory computer-readable storage medium having computer instructions therein, wherein the computer instructions are configured to cause a computer to implement a method of processing an image, comprising operations of:
performing an image processing on an original image to obtain a component image for brightness of the original image;
determining at least one of the original image and the component image as an image to be processed;
classifying a pixel in the image to be processed, so as to obtain a classification result;
processing the image to be processed according to the classification result, so as to obtain a target image; and
determining an image quality of the original image according to the target image.

16. The storage medium of claim 15, wherein the computer instructions are configured to cause the computer further to implement operations of: for each pixel in the image to be processed,
dividing the pixel into a first group in response to determining that a pixel value of the pixel is greater than a threshold value;
dividing the pixel into a second group in response to determining that the pixel value of the pixel is less than or equal to the threshold value; and
determining the first group and the second group as the classification result.

17. The storage medium of claim 16, wherein the computer instructions are configured to cause the computer further to implement operations of:
configuring a pixel value of a pixel in the first group as a first score;
configuring a pixel value of a pixel in the second group as a second score; and
obtaining the target image according to the first score and the second score.

18. The storage medium of claim 17, wherein the computer instructions are configured to cause the computer further to implement operations of:
determining a connected component of the original image according to the target image; and
determining the image quality of the original image according to the connected component.

19. The storage medium of claim 18, wherein the computer instructions are configured to cause the computer further to implement operations of:
determining an occlusion rate of the original image according to a ratio of a component area of the connected component to an image area of the original image; and
determining the image quality of the original image according to the occlusion rate.

20. The storage medium of claim 15, wherein the computer instructions are configured to cause the computer further to implement operations of:
determining a first level of difference between a foreground information of the original image and a background information of the original image;
determining a second level of difference between a foreground information of the component image and a background information of the component image; and
determining the original image or the component image as the image to be processed, according to the first level of difference and the second level of difference.
